(19) United States
(12) Patent Application Publication
(10) Pub. No.: US 2020/0250917 A1
(43) Pub. Date: Aug. 6, 2020

(54) INTERACTIVE RANDOM PRIZE GENERATION SYSTEM

(71) Applicant: Press Play Inc., Dallas, TX (US)

(72) Inventor: Benjamin Liss, Dallas, TX (US)

(73) Assignee: Press Play Inc., Dallas, TX (US)

(21) Appl. No.: 16/269,483

(22) Filed: Feb. 6, 2019

(51) Int. Cl. G07F 17/32

(52) U.S. Cl. CPC G07F 17/329; G07F 17/3213; G07F 17/3209; G07F 17/3244; G07F 17/3225; G07F 17/323

(57) ABSTRACT

A method, system, and computer readable storage to implement a content distribution system in which users can connect remotely to access content via a computer communications network. A server would utilize algorithms which typically incorporate a random element as to which of a plurality of users who have accessed content would be entitled to a potential distribution routed to the respective users across the network.

### BACKGROUND OF THE INVENTION

### Field of the Invention

The present general inventive concept provides a method, apparatus, and computer readable storage medium directed to an interactive random prize generation system.

### Description of the Related Art

Sweepstakes and random chance games have been available. Typically, winners are selected at the conclusion of a time period without any transparency (i.e. pick a name out of a hat). However, what is needed is a prize generation system that engages the user upon entry and throughout the time period by providing immediate and ongoing feedback as to the potential of winning until the conclusion.

### SUMMARY OF THE INVENTION

It is an aspect of the present invention to provide an improved prize generation system.

This improved prize generation system along with other aspects and advantages which will be subsequently apparent, reside in the details of construction and operation as more fully hereinafter described and claimed, reference being made to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a method to initiate contests, according to an embodiment;

FIG. 2 is a flowchart illustrating an exemplary method of implementing a method to determine entry scores, according to an embodiment;

FIG. 3 is a flowchart illustrating an exemplary method of initiating a contest and awarding prizes, according to an embodiment;

FIG. 4 is an example output illustrating how a user can submit their entry sequence, according to an embodiment;

FIG. 5 is an example output illustrating indicating to the user that the random sequences are being drawn, according to an embodiment;

FIG. 6 is an example output illustrating a score for a user's entry sequence, according to an embodiment;

FIG. 7 is an example output illustrating a user's best (lowest) score for a particular contest period, according to an embodiment;

FIG. 8 is an example output of a leaderboard showing the prize winners for a particular contest period, according to an embodiment;

FIG. 9 is a flowchart illustrating an exemplary method of initiating contests without computing scores, according to an embodiment;

FIG. 10 is a flowchart illustrating an exemplary method of determining winners of contests by picking random entries, according to an embodiment;

FIG. 11 is a flowchart illustrating an exemplary method of implementing a contest with scoring based on matching, according to an embodiment;

FIG. 12 is a flowchart illustrating an exemplary method of scoring entries, according to an embodiment;

FIG. 13 is a flowchart illustrating an exemplary method of administering a contest and awarding prizes, according to an embodiment;

FIG. 14 is a network diagram illustrating participants of the system, according to an embodiment; and

FIG. 15 is a block diagram illustrating an example of computer hardware which can be used to implement any computer utilized herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The inventive concept relates to a method, system, and computer readable storage in which users or players can earn entries into a sweepstakes, lottery, or other random chance drawing type of game. The user can perform qualifying actions, such as watching a video, etc., upon which the user would earn an entry and the entry can then enable the user to win a prize. There are numerous embodiments which will be described herein.

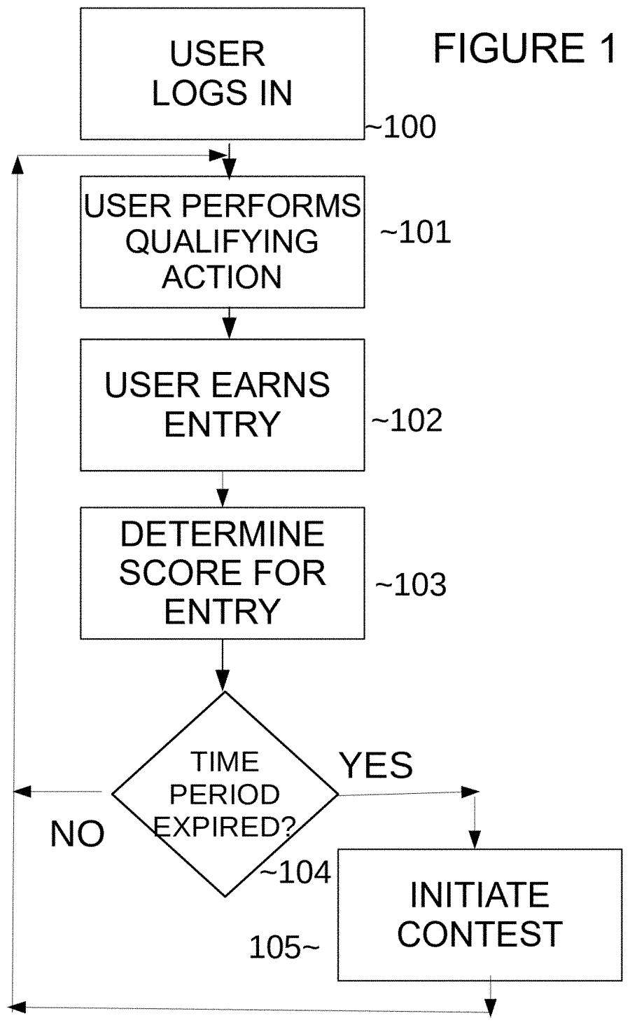

FIG. 1 is a flowchart illustrating an exemplary method of implementing a method to initiate contests, according to an embodiment.

The method can begin with operation 100, wherein the user logs into a system implementing the embodiments described herein. Each user would typically have a unique identifier (e.g., username, cookie identification, IP address, etc.) which enables the system to identify the user in order to make sure only the user's actions are credited to the specific user. Creating an account and logging in, or other similar identification measures, are known in the art. The identification operation of operation 100 can be performed automatically or manually by the user.

Note the methods described herein can be performed on a platform, such as a web site or a mobile application, that can implement the code required to perform the methods described herein. The content could be served (originated from) by a content server while the user would typically view the content on a remote computer utilized by the user using a computer communications network such as the internet.

From operation 100, the method proceeds to operation 101, wherein the user performs a qualifying action (e.g., watching a video, answering a survey, etc.) and is awarded an entry. If the qualifying action is watching a video, the video would typically have to be watched in its entirety in order to qualify. Typically, only certain content (e.g., video, survey, etc.) that is pre-selected by the game server would qualify the user to earn an entry. In an embodiment, in order to complete the content, the user would have to click a series of buttons and/or answer one or more questions about the content in order to verify that the content has been completed (viewed) by the user in its entirety. In an embodiment, a content server can provide a confirmation (e.g., a network transmission) to the game server that the content viewing by a particular user was completed. The confirmation can comprise information such as the date and time of the completion, the content being viewed, etc. In response to receiving the confirmation, the game server can initiate (provide) the entry to the user as a reward for having viewed the content.

If for example, the user performs a qualifying action, then the method proceeds to operation 102. Otherwise, the method can remain at operation 101 until the user performs a qualifying action.

In operation 102, the user earns an entry. An entry is a mechanism by which the user can gain a chance to enter a random chance game (e.g., lottery, sweepstakes, etc.) for the opportunity to win a prize.

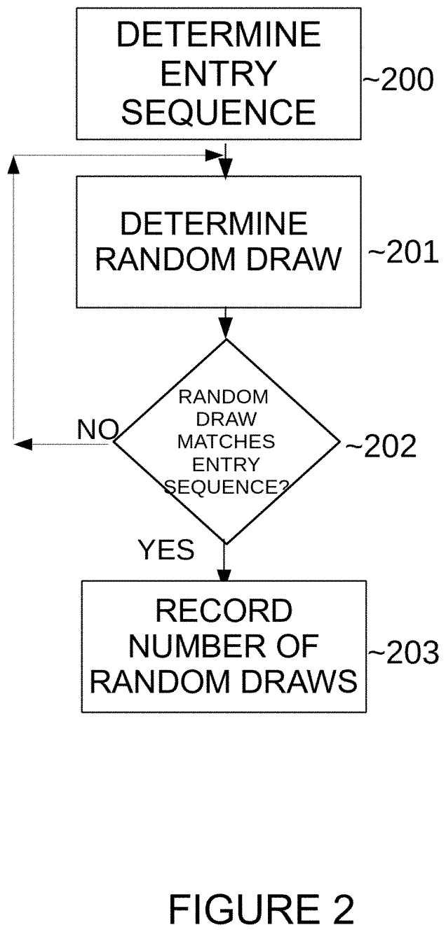

From operation 102, the method proceeds to operation 103, which determines a score for the entry. In this embodiment, each entry can receive a score which at the conclusion of the time period is then compared to scores of all other entries (all for the same time period) and winning score(s) will win prize(s). FIG. 2 illustrates one possible method of determining such a score, although it can be appreciated that other method(s) could be used as well.

From operation 103, the method proceeds to operation 104, which determines whether a time period has expired. There are continuously held contests (for example, once a day, once a week, etc.) in which all of the entries earned for that contest period (e.g., the previous 24 hours before the contest, the previous 7 days before the contest, etc.) constitute the entry pool for a particular contest. For example, a contest could be held every day at exactly noon, and all of the entries that were earned in the previous 24 hours would be entered into this particular contest.

If in operation 104 it is determined that a time period has expired, then the method proceeds to operation 105 which initiates a contest. In other words, each entry will have a particular contest associated with it depending on the time the entry was earned. For example, if contests are held every day at noon, and a particular entry was earned on one day at 11 am, then that particular entries' contest will be the one at the next upcoming noon. Each entry will be entered into the next contest to take place. Once a contest takes place then all entries in that contest are no longer valid for future use.

Typically, a user would earn an entry and choose to enter that entry (submit) immediately after earning it (in between operations 102 and 103), thereby earning a score right away (operation 103). In another embodiment, a user could earn an entry but choose to defer entering that entry until a later time (and thus earning the score at that later time). In this way, a user could accumulate entries and enter multiple entries for the same contest on the same day. For example, a user could earn an entry for a daily noon contest each day for a week and then enter all of those entries in a Sunday noon contest. Although in an embodiment, an entry for a daily contest could not be utilized for a weekly contest. As such, after operation 102, typically operation 103 immediately follows where the player did not defer the entry and earns a score. However, if the player chooses to defer the entry, then in between operations 102 and 103, the player can defer earning a score and can choose the time/contest the player wishes to enter that entry, and upon that contest beginning, that entry would earn a score and be utilized for that contest.

If in operation 104, the time period has not expired (e.g., the next contest is not yet starting) then the method returns to operation 101 where the user can earn additional entries. After operation 105, the contest has been completed, and the method returns to operation 101 where the user can earn additional entries.

Note that typically users will not be able to earn unlimited entries, and there will be a cap on the number of entries a user can earn for each contest (e.g., 1, 5, or other number).

FIG. 2 is a flowchart illustrating an exemplary method of implementing a method to determine entry scores, according to an embodiment.

In operation 200, an entry sequence is determined. The entry sequence can be a number (e.g., from 0 to 9,999 or any other range), a sequence of “emojis” or other indicia, etc. The entry sequence can be generated automatically by the computer or manually selected by the user. For example, the user can type in any five-digit number as the entry sequence, or the computer can generate a random five-digit sequence. Emojis can be defined as any of various small images, symbols or icons used in text fields in electronic communication (e.g., text messages, emails, social media, etc.) to express the emotional attitude of the writer, convey information succinctly, communicate a message playfully without using words, etc.

From operation 200, the method proceeds to operation 201, which determines a random draw sequence.

The random draw sequence is a randomly determined (by the computer) sequence of the same format as the entry sequence (e.g., if the entry sequence is five emojis then the random draw sequence is five emojis, if the entry sequence is four digits then the random draw sequence is four digits, etc.) Note that in operation 201 a counter is maintained of how many times operation 201 has been performed (i.e., how many random draw sequences were generated) for this particular entry sequence.

From operation 201, the method proceeds to operation 202, which determines whether the entry sequence matches (equals) the last random draw sequence (determined in operation 201). If not, then the counter increases by one and the method returns to operation 201.

If in operation 202, if it is determined that the last random draw sequence (determined in operation 201) matches the entry sequence (operation 200), then the method proceeds to operation 203. Note that the system now has counted a number of draws it took (starting with 1 as the first draw for this particular entry) to match the entry sequence.

In operation 203, the system records the counter (i.e., the number of random draw sequences that were generated (operation 201) before a random draw sequence matched the entry sequence). The counter value would be stored in a database and associated with the particular user and entry that it was generated for. Typically, it is better for the user to get the lowest possible counter (number of draws).

As an example of the method illustrated in FIG. 2, a user picks a four digit number such as 1,234, and then the computer continuously generates random four digit numbers until it generates 1,234. The number of attempts the computer made to match the random four-digit number with the user entry (the number of numbers the computer generated) is the score. If the computer randomly generated 1,234 on its very first try (random number generated) then the score would be 1 (typically the best score). If the computer generated 1,234 after 5,000 tries (random number generated) then its score would be 5,000 (total number of tries). The computer may take a little time running the method in FIG. 2 as it would keep running until the entry sequence was matched by the random draw sequence.

All entries would have a score generated (and associated) with each one. Then, a contest would initiate (typically at predetermined times) and the best score(s) out of all of the entries would win a prize.

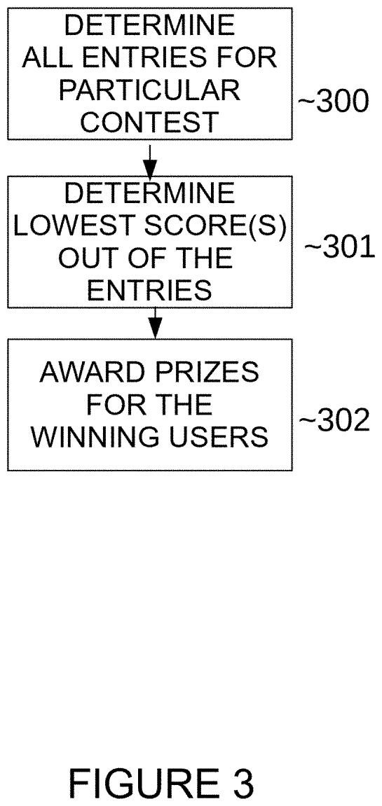

FIG. 3 is a flowchart illustrating an exemplary method of initiating a contest and awarding prizes, according to an embodiment.

In operation 300, a set of entries is determined for a particular contest. Typically, the set of entries is all of the entries that have not yet been assigned a relative ranking (e.g., all of the entries that were submitted since the last contest).

From operation 300, the method proceeds to operation 301, which determines a lowest score(s) (for example the five lowest) out of all of the respective entries from operation 300. Each entry is associated with a score and receives a relative ranking. In an alternative embodiment, the highest score(s) can be determined.

From operation 301, the method proceeds to operation 302 which, for the lowest scores from operation 301, would award the users who submitted those respective entries a corresponding prize. In other words, a user who submitted a respective entry can be considered to own that entry and is entitled to any prizes (or other incentives) associated with that particular entry. For example, the user with the very lowest score would be the winner and would get the best prize, the user with the second lowest score would be the runner-up and get a second-best prize, etc. Note that now that the contest is over, each user starts a new (the previous entries and scores can be discarded for purposes of beginning and conducting a new contest).

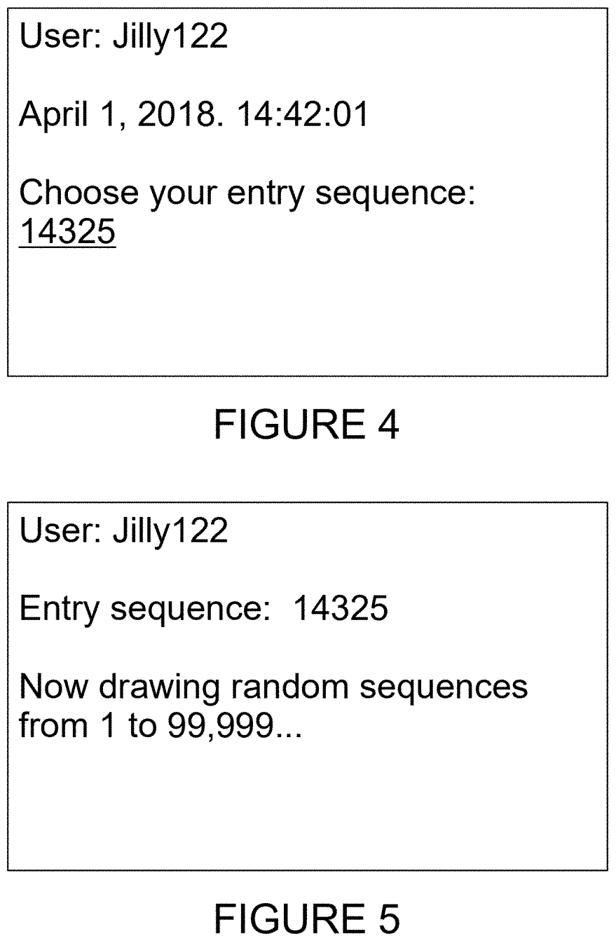

FIG. 4 is an example output illustrating how a user can submit their entry sequence, according to an embodiment.

The username for this particular user is “Jilly122” which is a unique identifier. The date/time is shown, and the user submits (by typing, clicking, etc.) her chosen entry sequence (from 1 to 99,999). Note that instead of digits it can be emojis, icons, or any other type of indicia.

FIG. 5 is an example output illustrating indicating to the user that the random sequences are being drawn, according to an embodiment.

The computer (any computer on the system, but typically the remote server and not the computer the user is actually using to prevent hacking) will now continuously generate random numbers until it generates one that matches the entry sequence (“14325”). The random numbers can optionally be displayed as they are generated.

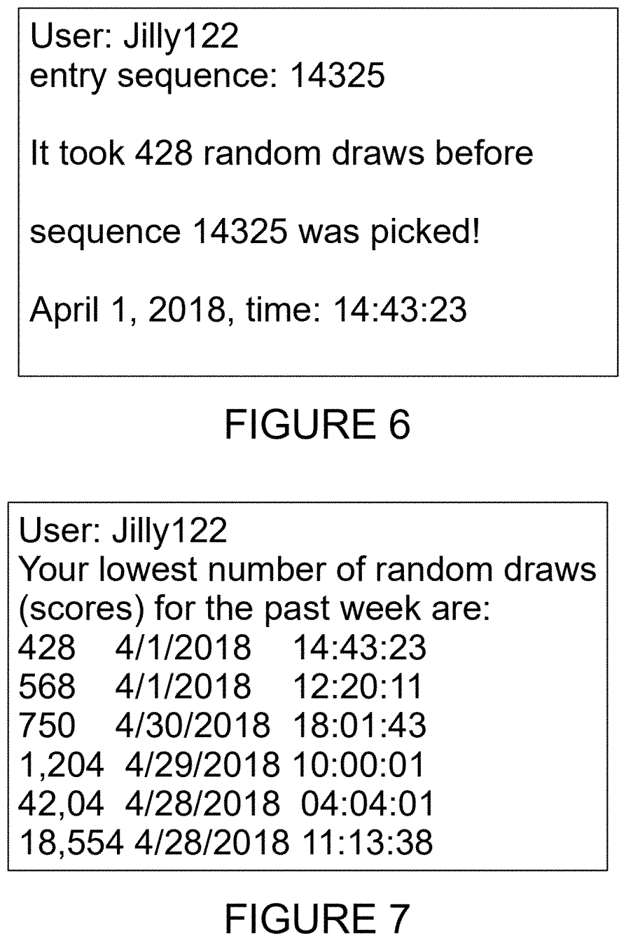

FIG. 6 is an example output illustrating a score for a user's entry sequence, according to an embodiment.

This output shows that the entry sequence was finally generated by the computer (random number generated) on the 428th attempt.

FIG. 7 is an example output illustrating all of a user's scores for a particular contest period, according to an embodiment.

All of the user's scores for the upcoming contest are displayed along with the date and time they were submitted. Note that a user can win more than one prize in a particular contest (e.g. the user has multiple scores and more than one of the scores are good enough to win a prize for a contest).

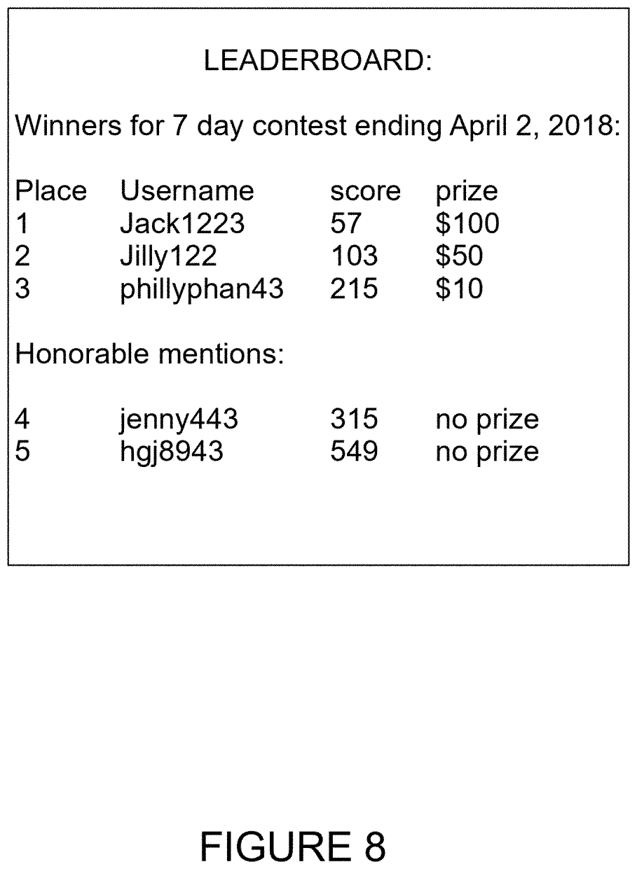

FIG. 8 is an example output of a leaderboard showing the prize winners for a particular contest period, according to an embodiment.

In an optional embodiment, the leaderboard would also be shown during the contest period. This “live” leaderboard would enable the user to see the relative rank of their score before the time period expires and the contest is initiated. In this manner, each user can see how they currently stand in the contest which could create more excitement for the player. This can be performed after operation 103 but before operation 105. The user could choose to repeat Operations 101-103 to improve the score. The user would only be entitled to view the leaderboard after completing Operation 103, but would be able to continuously check the leaderboard to see an updated relative rank. A user who had earned, but not yet submitted an entry would not be able to view the leaderboard.

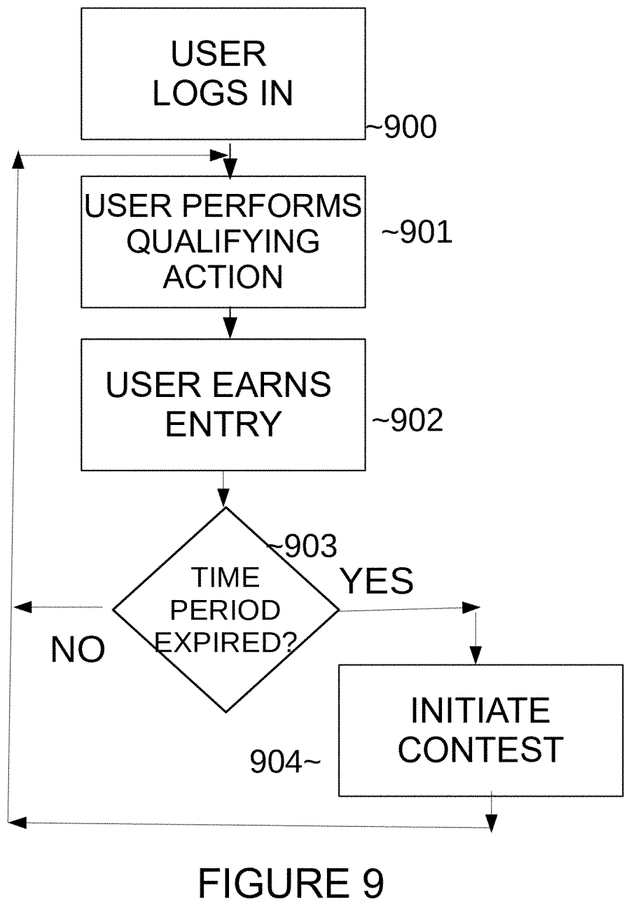

FIG. 9 is a flowchart illustrating an exemplary method of initiating contests without computing scores, according to an embodiment. FIG. 9 operates similarly to FIG. 1 (i.e. each operation in FIG. 9 operates the same as its counterpart in FIG. 1), but there is no determination of scores for each entry (operation 103). Instead each entry has its own unique identifier (e.g., number, etc.) which is used in the subsequent contest.

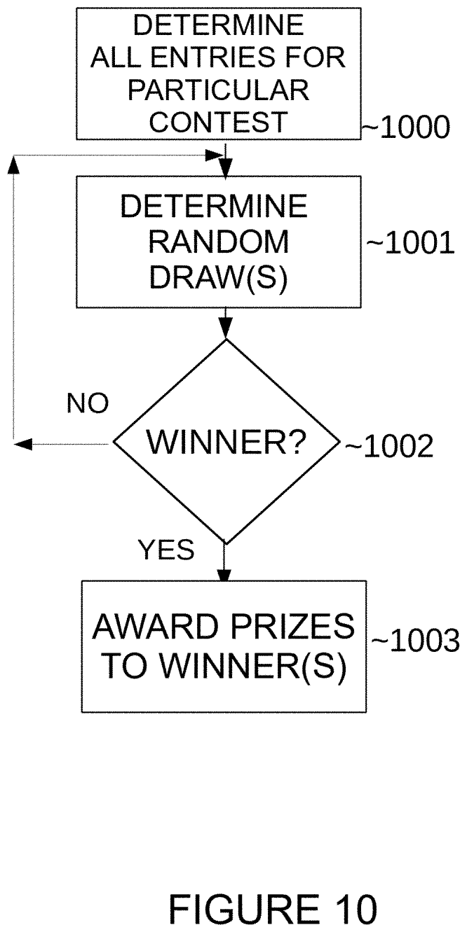

FIG. 10 is a flowchart illustrating an exemplary method of determining winners of contests by picking random entries, according to an embodiment.

In operation 1000, all entries for a particular contest are determined. This is performed the same as in operation 300.

From operation 1000, the method proceeds to operation 1001, which determines a random draw. In other words, a number or other identifier is randomly determined which corresponds to the same format as the entry identifiers.

For example, if each entry has a unique number from 0 to 1,000,000, then a random number from 0 to 1,000,000 is determined.

Then, in operation 1002, it is determined if there is a matching (winning) entry out of the users for this contest (determined in operation 1000) to the random number (draw) determined in operation 1001. In other words, it is determined if the random draw from operation 1001 has drawn a winner for this particular contest. If not, then the method returns from operation 1002 to operation 1001.

If after operation 1002, more winners are still needed (e.g., the contest has 10 winners and less than 10 winners have been determined) then the method would also return back to operation 1001.

If in operation 1002, a winner was drawn and enough winners for this particular contest have been drawn, then the method proceeds to operation 1003. In other words, some contests may only have one winner but some contests may have more than one winner (depending on the system administrators), such as 5, 10, 100 or more winners, etc. As such, if there is predetermined to be W winners, then W matches would need to be successfully drawn in operations 1001-1002 before the method would proceed to operation 1003. If an entry (entry sequence) has already been matched then it typically would not be available to match (win) again.

In operation 1003, all of the winners for this particular contest that have been determined are then awarded their prizes.

In an alternate embodiment, instead of drawing random numbers and matching them to entries, random entries (out of the entries that have been determined to be active for a particular contest) can be drawn at random. For example, if 1,234 entries are determined to be active for a particular contest (e.g., operation 1000), and 5 winning entries are needed, then five random entries out of the 1,234 active entries are drawn at random and are considered the winning entries.

In yet a further embodiment, users can select numbers or indicia and a matching game can be played. That is, random numbers or indicia are drawn and the number of matches between the user selected numbers or indicia and the random numbers or indicia are tabulated. At the end of a contest period, the users with the most numbers of matches would be considered the winners (and would win respective prizes).

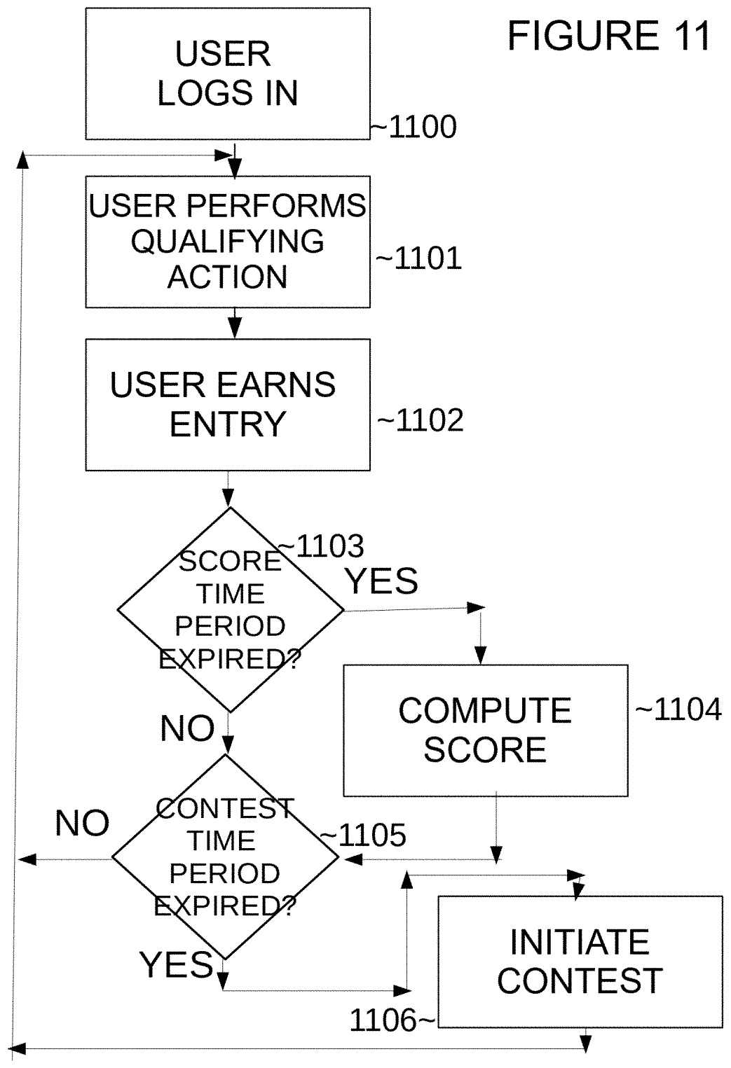

FIG. 11 is a flowchart illustrating an exemplary method of implementing a contest with scoring based on matching, according to an embodiment.

The method can begin with operation 1100, in which the user logs in. This can be performed the same as in operation 100.

From operation 1100, the method proceeds to operation 1101, wherein the user performs a qualifying action to earn an entry. This can be performed the same as operation 101.

From operation 1101, the method proceeds to operation 1102, in which the user earns an entry. The user is prompted to manually select a number or set of indicia or the computer can randomly generate one for this particular entry. For example, selection can be a five (or any other number of digits) digit number or a set of five (or any other number) emojis (or any other type of indicia). Emojis (also known as emoticons) are defined earlier in Paragraph 37. Examples of emojis can be [symbol] (white happy), [symbol] (white sad), [symbol] (black happy), etc. There can be for example 50 (or any other number) types of emojis the user can select from. The user could select five (or any other number of) emojis, although the user cannot select the same emoji (or digit) twice. This is similar to picking lottery numbers where the user can select X (e.g., 5) numbers from a set of Y (e.g., 50) numbers wherein no number can be picked twice and the order does not matter. At a later time, the computer will draw a set (or a plurality of sets) of five random emojis and so the user's goal is to pick the same emojis that will be picked by the computer later on (but of course the user has no way to predict what the computer will really pick). The system would store the user's pick for the particular entry so it can be retrieved later when this entry is scored.

From operation 1102, the method proceeds to operation 1103, which determines whether a score period expires (i.e. whether it is time to score the latest round of entries). Periodically (e.g., once every hour, every midnight, etc.) the latest entries that have not yet been scored will be given a score. If it is not time to score entries, then the method proceeds to operation 1105. If it is time to score entries (for example, every hour (e.g., 1:00 pm, 2:00 pm, 3:00 pm, etc.) the latest set of (unscored) entries will be scored), then the method proceeds to operation 1104.

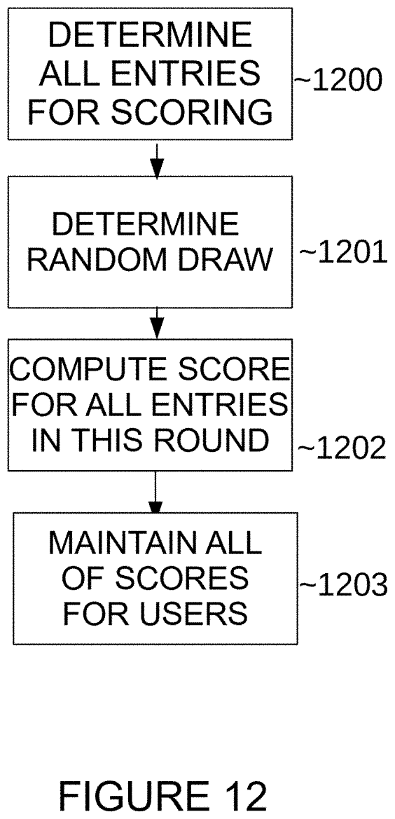

In operation 1104, the latest set of unscored entries (all entries earned by users which have not yet been scored, typically all entries earned between the current scoring session and the previous one) will now be given a score, which is illustrated in FIG. 12 (operations 1200 to 1203).

Once operation 1104 is completed (the entries have all been scored), then the method proceeds to operation 1105. In operation 1105, a determination is made whether the contest time period has expired. This is performed as in operation 104. Note that the contest time period is typically longer than the score time period. Typically, there will be many times the score for entries (operation 1104, FIG. 12) has been computed before the contest itself is scored (after the contest time period has expired). The contest time period can be a period time (e.g., every Monday at noon, ever three days, one a month, etc.) If the contest time period has not yet expired (not time yet for the next contest to be initiated), then the method returns to operation 1101. Note that FIG. 11 (like FIG. 1) is typically being performed for a plurality of different users simultaneously, each user using their own computer (remote from the server/database implementing the overall method).

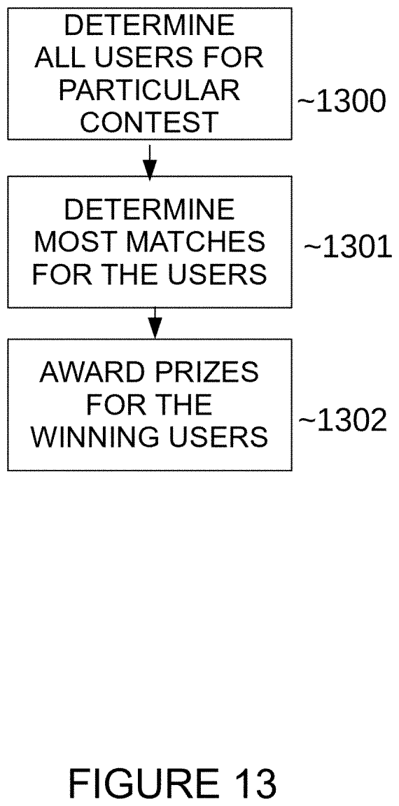

If in operation 1105, it is determined that the contest time period has expired and it is now time to score the next contest (i.e., determine which users win this contest based on their scores from their entries), then the method proceeds to operation 1106 which initiates a new contest. Operation 1106 is performed as illustrated in FIG. 13.

FIG. 12 is a flowchart illustrating an exemplary method of scoring entries, according to an embodiment.

In operation 1200, all entries that have not yet been scored are determined so they can be scored. Typically all entries earned between the time the last scoring time (the last time the method illustrated in FIG. 12 was implemented) and the current scoring time are the entries that need to be scored.

From operation 1200, the method proceeds to operation 1201, which determines a random draw. For example, if emojis are being used (picked by the user in operation 1102) then emojis are randomly picked. If digits were picked by the user in operation 1102 then digits are randomly picked. For example, if in operation 1102 the user picked 5 emojis out of 50 possible emojis, then the computer will pick five random emojis out of the same 50 possible emojis (noting that no emoji can be selected twice and the order the emojis are picked does not matter). Each emoji may have its own numerical reference/identifier used internally by the computer, although this numerical reference/identifier would typically not be displayed to the users.

From operation 1201, the method proceeds to operation 1202, which computes the score for all of the entries for this round/scoring session (determined in operation 1200). The score is the number of matching emojis in the set of emojis picked. For example, if in operation 1102, the user picked the following five emojis: white happy/white sad/white glasses/black frown/black crying, and then the computer picked the following set of five emojis at random: yellow happy/white frown/black crying/white crying/white sad, then there are two emojis that are common to both (the user's pick in operation 1102 and the computer's pick in operation 1201). As such, this particular entry gets a score of 2, and the user who submitted this particular entry gets 2 added to the user's total score. All of the entries determined in operation 1200 are determined in this manner.

From operation 1202, the method proceeds to operation 1203, which maintains a total score for all of the users for the upcoming contest. Thus, each score for each entry is added to the total of the user who submitted that respective entry. For example, if a certain entry has a score of 4 (4 matches wherein order does not matter), then the user who submitted the certain entry will have their total score increased by 4. As such, all of the users who have entries in this particular scoring session can have their scores adjusted (increased) by their scores from their matches, although of course if an entry has zero matches then the score is 0 which means that user's total score is unaffected. Note that each user can have multiple entries that are scored in this particular scoring session.

Note that all of the operations in FIG. 12 (and in fact all of the operations described herein) can be displayed to the user as they are occurring. For example, the random draw in operation 1201 can be displayed to all users (or just the users who have active entries in the scoring) so they can follow along. The scores determined in operations 1202-1203 can also be displayed to the users. Functionality is provided that a user can at any time the user wishes (by operating a graphical user interface, etc.) view his/her total score (the sum of all scores of all entries submitted/owned by the user for a particular upcoming contest) so they user can follow along his/her progress.

FIG. 13 is a flowchart illustrating an exemplary method of administering a contest and awarding prizes, according to an embodiment. When operation 1106 is performed a contest is conducted which is performed according to the method illustrated in FIG. 13.

In operation 1300, all users that have earned entries (which were submitted and scored) during the time period for this particular contest are determined. These are the users that are compared against each other for the purposes of this contest.

From operation 1300, the method proceeds to operation 1301, which determines who has the most matches (highest score) out of the set of users determined in operation 1300. The highest X scores can be ranked, wherein X can be 1, 2, 1-10, 1-50, etc. These are the winners. A leaderboard can also be displayed which lists the winners for this particular contest.

From operation 1301, the method proceeds to operation 1302, which awards prizes to the winning users determined in operation 1301. This can be performed as described with regard to operation 302.

All contests (or similar determinations) described herein (e.g., operations 105, 904, 1106, etc.) can be conducted automatically and periodically, that is at predetermined times (e.g., each day at midnight, every Monday at noon, every second day at 7:00 am, etc.) This is also the same as conducting a contest after a predetermined period of time elapses (e.g., every day, etc.) A uniform time will be used (e.g., Eastern Standard Time) so that users all around the world would be in the contests together at the same time. The conduct of the contests (e.g., all winners, losers, random numbers drawn, etc.) can be displayed to all users (who wish to watch them) in real time as the contests are being conducted. Note that in an embodiment, after each contest has been completed, scores can optionally be reset (to zero) so each user starts out equally for a new contest period.

All data involved in FIG. 13 (e.g., all users for a particular contest identified by their usernames, all scores for all entries in the contest, total scores for users in the contest, and any other value, etc.) can all be displayed at any time to the player (typically on their own remote computing device) so players can follow along the progress of each contest and see how they stand.

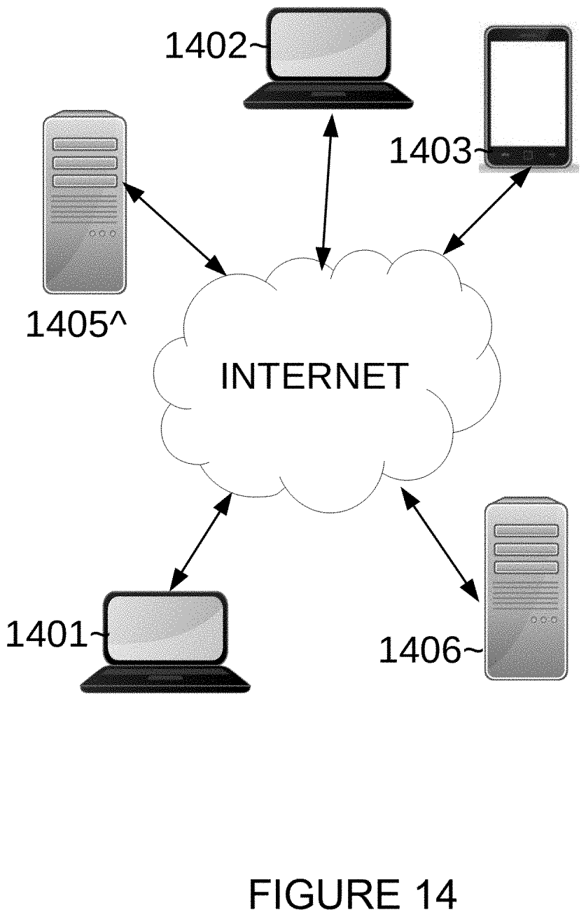

FIG. 14 is a network diagram illustrating participants of the system, according to an embodiment.

Any number of remote computers 1401, 1402, 1403, etc., used by respective remote users, can be connected to the system via the Internet. The remote computers can be laptops, notebooks, tablets, cell phones, or any other such device which can connect to the Internet. Content server 1405 is a server/database that is connected to the Internet to send and receive content (e.g., videos, surveys, etc.) to the remote users on remote computers 1401, 1402, 1403. The content server 1405 can also serve/administer a platform. While only one content server 1405 is shown, it is contemplated that there can be a large number of content servers 1405 which all serve their respective content (e.g., videos, web surveys, etc.) to the remote computers 1401, 1402, 1403. A game server 1406 that is connected to the internet is utilized to administer all of the features described herein (e.g., maintaining the user lists and entries, determining any random determinations, causing the outputs (e.g., leaderboards, etc.) be displayed on the remote users' computers 1401, 1402, 1403, determining whether prizes are earned, awarding any earned prizes, and any other features described herein or needed for operation of the system/method). The game server 1406 would work alongside the content server 1405. For example, the content server could be serving a video which is playing on a remote user's computer (e.g. 1401) which allows the remote user to earn an entry, and the game server 1406 would also be in communication with the remote computer 1401 in order to cause all of the features described herein to occur. Note that all entities illustrated in FIG. 14 would typically be at different physical locations apart from each other (possibly far apart such as in different cities, countries, etc.) and all communications there between will be by way of the internet (or other computer communications network).

Note that any participant (e.g., remote users, game server, content server, etc.) of the system can perform any aspect of the features described herein and can work with any other participant to share roles and/or communicate any information among the participants. In other words, the methods/features of the method can be performed by one or more of any of these participants working together.

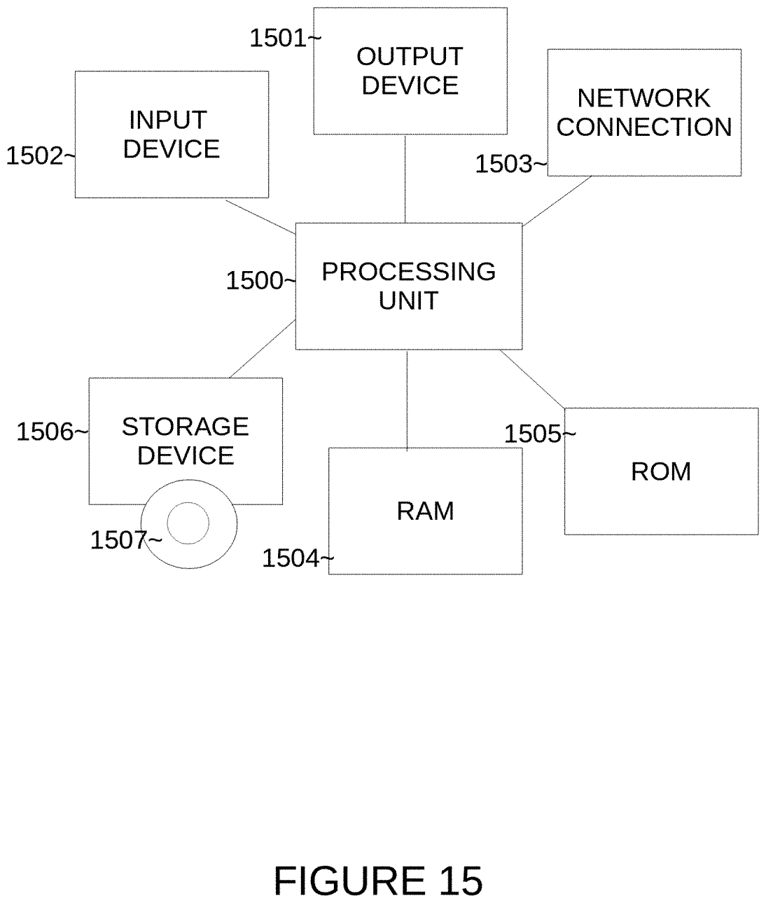

FIG. 15 is a block diagram illustrating an example of computer hardware which can be used to implement any computer utilized herein, according to an embodiment. The computer can also be any computing device, such as a cellular phone, tablet, server, database, personal computer, etc.

A processing unit 1500 which comprises a processor (such as a microprocessor) and any associated components (e.g., power supply, bus, cache, etc.) is connected to an electronic output device 1501, such as an LCD monitor, touch screen, CRT, display, etc., which is used to display to the user any aspect/output/state of the method, and an input device 1502, such as buttons, a touch screen, a keyboard, mouse, etc., which can be used to input from the user any decision/input made by the user. All values involved in any method/feature described herein can be displayed on the output device 1501. All methods described herein can be performed by the processing unit 1500 (working alone or in combination with other processors/processing units) by loading and executing respective instructions. Multiple processing units can also work in collaboration with each other in the same or different physical location. The processing unit 1500 can also be connected to a network connection 1503, which can connect the processing unit 1500 to a computer communications network such as the Internet, a LAN, WAN, etc. The processing unit 1500 is also connected to a RAM 1504 and a ROM 1505. The processing unit 1500 is also connected to a storage device 1506 which can be a disk drive, DVD-drive, CD-ROM drive, flash memory, etc. A non-transitory computer readable storage medium 1507 (e.g., hard disk, CD-ROM, etc.), can store a program which can control the electronic device to perform any of the methods/features described herein and can be read by the storage device 1506. A program (e.g. an application or “app”) can be executed by the processing unit 1500 in order to perform any of the methods/embodiments described herein. Such application can be downloaded from the internet by the processing unit 1500 via an online store (e.g. “app store” or “play store”). Any computer described herein can be utilized to implement the methods described herein, working individually or in conjunction with other computers.

While one processing unit is shown, it is contemplated that one or more such processors can work together in the same or different physical location to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.). All features and embodiments described herein can be combined with each other without limitation.

Note that any determination described herein can be performed by executing code programmed to make that determination, which can include querying a relational database which stores all of the relevant information described herein in order to make the necessary determinations (e.g., determining the proper pool of entries, users, etc.) All elements described herein (e.g., users, entries, etc.) can be stored in the relational database (which is typically part of or connected to the game server) 1406 along with all of their respective attributes (time earned, time played, etc.)

Note that the functionality to implement all of the features described herein should all be programmed on the “back end.” That means that typically, each user would not need to download/install any programs, apps, etc., in order to experience the functionality described herein, although in an embodiment such download/installation can still be required. The web sites, platforms, viewers, can all be programmed using any available programming languages, protocols, etc., in order to implement all of the methods/features herein on the user's own computer (e.g., cell phone, tablet, laptop computer, personal computer, etc.) However, in an embodiment, it may be necessary for a user to download a code/program in order to enable all of the features described herein. This can be a “plug-in” which downloads and installs into a user's browser, an app which can be installed on a cell phone or personal computer or a program that installs on a computer/cell phone, etc. This program would have code which would instruct the user's computer/browser to perform all of the features described herein.

Note that a user can also login to the system (e.g. into an account maintained by the game server 1406 or other server). The game server 1406 can maintain a unique user account for each user, and this account would store all of the user's entries, scores, etc. and all other information known about the user (e.g. his/her successful awards of prizes, etc.) When the user installs the plug-in or app, the user can enter identifying information (e.g., email address, username, password, etc.).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
at least one processor executing computer readable instructions which causes the following operations:
receiving a confirmation that a user completed viewing a content;
in response to the confirmation, providing the user an entry;
determining an entry sequence;
determining a score for the entry by counting a total number of random draws before a last random draw matches the entry sequence, wherein the total number of random draws is the score;
conducting a contest periodically, wherein the conducting of the contest comprises determining a plurality of lowest scores for a set of entries in the contest, and awarding prizes to respective users who own the plurality of lowest scores.

2. The method as recited in claim 1, wherein the determining the entry sequence generates the entry sequence randomly.

3. The method as recited in claim 1, wherein the determining the entry sequence receives the entry sequence from the user who manually selects the entry sequence.

4. The method as recited in claim 1, wherein the entry sequence is a number.

5. The method as recited in claim 1, wherein the entry sequence is a series of emojis or other indicia.

6. The method as recited in claim 1, wherein a plurality of the contests are conducted, each contest being initiated after a predetermined period of time elapses.

7. The method as recited in claim 1, further comprising displaying to a plurality of users a leaderboard comprising the plurality of lowest scores.

8. The method as recited in claim 1, wherein the content is a video.

9. The method as recited in claim 8, wherein the completed viewing the content comprises watching the video in its entirety.

10. An apparatus, comprising:
at least one processor connected to the internet, the at least one processor connected to at least one computer readable storage storing computer readable instructions, the computer readable instructions programmed to cause the at least one processor to perform:
receive a confirmation that a user completed viewing a content;
in response to the confirmation, providing the user an entry;
determine an entry sequence;
determine a score for the entry by counting a total number of random draws before a last random draw matches the entry sequence, wherein the total number of random draws is the score;
conduct a contest periodically, wherein the conducting of the contest comprises determine a plurality of lowest scores for a set of entries in the contest, and award prizes to respective users who own the plurality of lowest scores.

11. The apparatus as recited in claim 11, wherein the computer readable instructions are further programmed such that the determine the entry sequence generates the entry sequence randomly.

12. The apparatus as recited in claim 11, wherein the computer readable instructions are further programmed such that the determine the entry sequence receives the entry sequence from the user who manually selects the entry sequence.

13. The apparatus as recited in claim 11, wherein the computer readable instructions are further programmed such that the entry sequence is a number.

14. The apparatus as recited in claim 11, wherein the computer readable instructions are further programmed such that the entry sequence is a series of emojis or other indicia.

15. The apparatus as recited in claim 11, wherein the computer readable instructions are further programmed such that a plurality of the contests are conducted, each contest being initiated after a predetermined period of time elapses.

16. The apparatus as recited in claim 11, wherein the computer readable instructions are further programmed to display to a plurality of users a leaderboard comprising the plurality of lowest scores.

17. The apparatus as recited in claim 11, wherein the computer readable instructions are further programmed such that the content is a video.

18. The apparatus as recited in claim 18, wherein the computer readable instructions are further programmed such that the completed viewing the content comprises watching the video in its entirety.
